(19) United States
(12) Patent Application Publication
(10) Pub. No.: US 2025/0278870 A1
(43) Pub. Date: Sep. 4, 2025

(54) SYSTEM FOR RASTERIZING VEHICLE TELEMETRY DATA

(71) Applicant: GM Global Technology Operations LLC, Detroit, MI (US)

(72) Inventors: Joon Hwang, Pflugerville, TX (US); Christian Haller, Austin, TX (US); Ibrahim Onifade, Katy, TX (US); Leila Ghorban Zadeh, Seattle, WA (US); Shu Chen, Rochester Hills, MI (US); Mason David Gemar, Cedar Park, TX (US); Fan Bai, Ann Arbor, MI (US); Gui Chen, Sterling Heights, MI (US)

(21) Appl. No.: 18/591,196

(22) Filed: Feb. 29, 2024

(51) Int. Cl. G06T 11/20; G01C 21/00; G06T 11/40

(52) U.S. Cl. CPC G06T 11/203; G01C 21/3841; G06T 11/40

(57) ABSTRACT

A system for rasterizing telemetry data collected from a plurality of vehicles into map content includes one or more central computers in wireless communication with the plurality of vehicles that are each situated within a predefined geofenced area. The one or more central computers receive the telemetry data from each of the plurality of vehicles. The one or more central computers determine a two-dimensional probability distribution indicating a probability density of the plurality of vehicles over a predefined period of time along a particular road segment located within the predefined geofenced area.

### INTRODUCTION

The present disclosure relates to a system and method for rasterizing telemetry data received from a plurality of vehicles into map content including probability density images that indicate a probability density of vehicles over a specified period of time along a particular road segment.

An autonomous vehicle executes various tasks such as, but not limited to, perception, localization, mapping, path planning, decision making, and motion control. Autonomous vehicles rely upon map data for many of the tasks that are executed such as localization, mapping, and path planning. It is to be appreciated that different versions of map data representing the same geographical area may be generated, where each version of the map data is generated from different data sources.

One example of a version of map data is based on telemetry data, which may be collected from numerous vehicles and combined based on various aggregation and rasterization algorithms to determine various types of map content. However, several challenges exist when attempting to create map content based on telemetry data. First, it is to be appreciated that data representing a trajectory of a vehicle is temporally sparse and may not be spatially distributed in a uniform manner. In addition to temporal sparsity, in some implementations the telemetry data may contain significant noise, as vehicles often travel through areas not intended to be mapped. Furthermore, it is also to be appreciated that the amount of telemetry data that is aggregated and analyzed to create map content is vast in size. Merely by way of example, a big data server that aggregates telemetry data collected from vehicles across the country typically processes several billions of records per year. It is difficult to process vast amounts of telemetry data in a scaled manner to create map content. Finally, telemetry data collected from an individual vehicle represents the path of the individual vehicle, and not the geometry of the roadway. Therefore, respective attributes need to be inferred from aggregated data.

Thus, while maps for autonomous vehicles achieve their intended purpose, there is a need in the art for an improved approach for building a map based on telemetry data that alleviates the above-mentioned challenges.

### SUMMARY

According to several aspects, a system for rasterizing telemetry data collected from a plurality of vehicles into map content is disclosed. The system includes one or more central computers in wireless communication with the plurality of vehicles that are each situated within a predefined geofenced area, where the one or more central computers receive the telemetry data from each of the plurality of vehicles. The one or more central computers execute instructions to receive road network data representing a road network for the predefined geofenced area, where the road network is a network graph that models roadways based on a plurality of road segments. The one or more central computers execute instructions to execute one or more map matching algorithms to perform topology matching that aligns a plurality of telemetry data points with a topology of the road network, where the plurality of telemetry data points each represent a trajectory of one of the plurality of vehicles. The one or more central computers execute instructions to calculate a spline that connects the plurality of telemetry data points to one another, where the spline represents a trajectory of a single vehicle. The one or more central computers execute instructions to determine a plurality of interpolated telemetry data points positioned at equidistant intervals from one another along the spline. The one or more central computers execute instructions to execute one or more line drawing programs that draw a line including a plurality of discrete pixels, where the plurality of discrete pixels, which are expressed in image space, are representative of the interpolated telemetry data points, which are expressed in Euclidean space. The one or more central computers execute instructions to determine a two-dimensional probability distribution indicating a probability density of the plurality of vehicles over a predefined period of time along a particular road segment located within the predefined geofenced area based on a plurality of lines that each correspond to one of the plurality of vehicles.

In another aspect, the one or more central computers execute instructions to transform the two-dimensional probability distribution into a rendered probability density image.

In yet another aspect, the rendered probability density image is expressed as one of the following: a grayscale and a red, green, blue (RGB) image.

In an aspect, the two-dimensional probability distribution includes an aggregated line and a probability boundary.

In another aspect, the aggregated line is a solid line and represents an aggregation of the plurality of lines that each correspond to one of the plurality of vehicles.

In yet another aspect, the probability boundary surrounds the aggregated line and is representative of a global positioning system (GPS) boundary error of each of the plurality of vehicles located within the predefined geofenced area.

In an aspect, the one or more central computers execute instructions to filter the telemetry data based on one or more telemetry data parameters.

In another aspect, the one or more telemetry data parameters include one or more of the following: GPS boundary error, vehicle trajectories including temporal gaps that exceed a predefined period of time, a number of trajectories, and sample speed.

In yet another aspect, the one or more central computers execute instructions to execute a parametric spline algorithm to calculate the spline.

In an aspect, the parametric spline algorithm is a parametric cubic B-spline algorithm.

In another aspect, a distance measured between the equidistant intervals is determined based on the specific application of the map content. In yet another aspect, the line is an anti-aliased line.

In an aspect, the telemetry data indicates one or more of the following: a position of a specific vehicle, GPS boundary error, vehicle speed, heading, elevation, and a hashed vehicle identifier corresponding to each timestamp.

In another aspect, a method for rasterizing telemetry data collected from a plurality of vehicles into map content. The method includes receiving, by one or more central computers, road network data representing a road network for a predefined geofenced area, where the road network is a network graph that models roadways based on a plurality of road segments. The method includes executing, by the one or more central computers, one or more map matching algorithms to perform topology matching that aligns a plurality of telemetry data points with a topology of the road network, where the plurality of telemetry data points each represent a trajectory of one of the plurality of vehicles. The method includes calculating, by the one or more central computers, a spline that connects the plurality of telemetry data points to one another, where the spline represents a trajectory of a single vehicle. The method also includes determining, by the one or more central computers, a plurality of interpolated telemetry data points positioned at equidistant intervals from one another along the spline. The method includes executing one or more line drawing programs that draw a line including a plurality of discrete pixels, where the plurality of discrete pixels, which are expressed in image space, are representative of the interpolated telemetry data points, which are expressed in Euclidean space. Finally, the method includes determining a two-dimensional probability distribution indicating a probability density of the plurality of vehicles over a predefined period of time along a particular road segment located within the predefined geofenced area based on a plurality of lines that each correspond to one of the plurality of vehicles.

In another aspect, the method includes transforming the two-dimensional probability distribution into a rendered probability density image.

In yet another aspect, a system for rasterizing telemetry data collected from a plurality of vehicles into map content is disclosed. The system includes one or more central computers in wireless communication with the plurality of vehicles that are each situated within a predefined geofenced area, where the one or more central computers receive the telemetry data from each of the plurality of vehicles. The one or more central computers execute instructions to receive road network data representing a road network for the predefined geofenced area, where the road network is a network graph that models roadways based on a plurality of road segments. The one or more central computers execute one or more map matching algorithms to perform topology matching that aligns a plurality of telemetry data points with a topology of the road network, where the plurality of telemetry data points each represent a trajectory of one of the plurality of vehicles. The one or more central computers execute instructions to calculate a spline that connects the plurality of telemetry data points to one another, where the spline represents a trajectory of a single vehicle. The one or more central computers execute instructions to determine a plurality of interpolated telemetry data points positioned at equidistant intervals from one another along the spline. The one or more central computers execute one or more line drawing programs that draw an anti-aliased line including a plurality of discrete pixels, where the plurality of discrete pixels, which are expressed in image space, are representative of the interpolated telemetry data points, which are expressed in Euclidean space. The one or more central computers determine a two-dimensional probability distribution indicating a probability density of the plurality of vehicles over a predefined period of time along a particular road segment located within the predefined geofenced area based on a plurality of anti-aliased lines that each correspond to one of the plurality of vehicles. The one or more central computers execute instructions to transform the two-dimensional probability distribution into a rendered probability density image.

In another aspect, the rendered probability density image is expressed as one of the following: grayscale and a red, green, blue (RGB) image.

In yet another aspect, the two-dimensional probability distribution includes an aggregated line and a probability boundary.

In an aspect, the aggregated line is a solid line and represents an aggregation of the plurality of lines that each correspond to one of the plurality of vehicles.

In another aspect, the probability boundary surrounds the aggregated line and is representative of a GPS boundary error of each of the plurality of vehicles located within the predefined geofenced area.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of the disclosed system that includes one or more central computers that receive telemetry data from a plurality of vehicles, according to an exemplary embodiment;

FIG. 2 is a block diagram illustrating the software architecture for the one or more central computers shown in FIG. 1, according to an exemplary embodiment;

FIG. 3 is an illustration of a road network including a plurality of telemetry data points that each represent a trajectory of one of the vehicles shown in FIG. 1 at a specific timestamp and a spline that connects the telemetry data points to one another, according to an exemplary embodiment;

FIG. 4 is an illustration of the road network shown in FIG. 3 including a plurality of interpolated telemetry data points positioned at equidistant intervals from one another, according to an exemplary embodiment;

FIG. 5 illustrates a single image tile and a plurality of discrete pixels, where the discrete pixels are the interpolated telemetry data points shown in FIG. 4 that have been rasterized, according to an exemplary embodiment;

FIG. 6 illustrates a line that is drawn based on the discrete pixels shown in FIG. 5, according to an exemplary embodiment;

FIG. 7 illustrates a two-dimensional probability distribution indicating a probability density of the vehicles located within the predefined geofenced area shown in FIG. 1, according to an exemplary embodiment;

FIG. 8 illustrates a rendered probability density image based on the two-dimensional probability distribution shown in FIG. 7, according to an exemplary embodiment; and

FIG. 9 is a process flow diagram illustrating a method for rasterizing the telemetry data received from the plurality of vehicles shown in FIG. 1 into the rendered probability density image shown in FIG. 8, according to an exemplary embodiment.

### DETAILED DESCRIPTION

The following description is merely exemplary in nature and is not intended to limit the present disclosure, application, or uses.

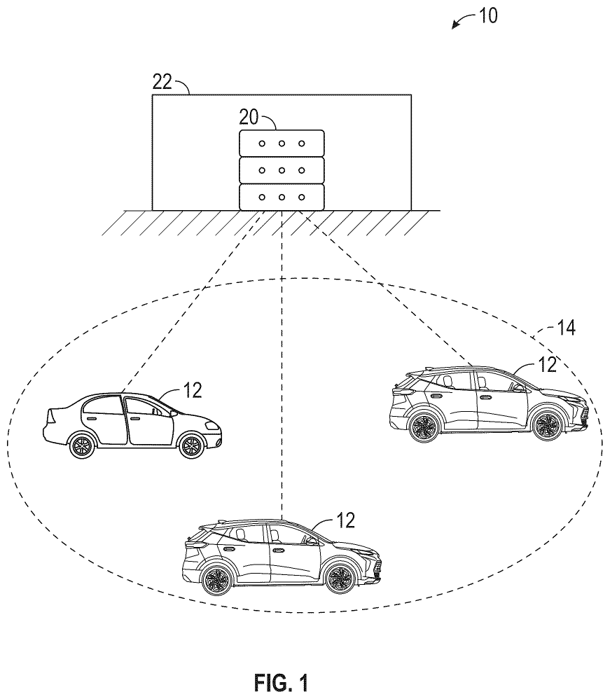

Referring to FIG. 1, an exemplary system 10 for rasterizing telemetry data collected from a plurality of vehicles 12 into map content is illustrated. The system 10 includes one or more central computers 20 located at a back-end office 22, where the one or more central computers 20 are in wireless communication with the plurality of vehicles 12. The plurality of vehicles 12 may include any type of vehicle having wireless capabilities connected to the back-end office 22 such as, but not limited to, a sedan, truck, sport utility vehicle, van, or motor home. The plurality of vehicles 12 are each situated within a predefined geofenced area 14, where the predefined geofenced area 14 represents a real-world geographical area that is defined by a virtual perimeter. The one or more central computers 20 receive telemetry data from each of the plurality of vehicles 12 located in the predefined geofenced area 14. The telemetry data received from each vehicle 12 located within the predefined geofenced area 14 indicates information such as, but not limited to, a position of a specific vehicle 12 (i.e., vehicle latitude and longitude), global positioning system (GPS) boundary error, vehicle speed, heading, elevation, and a hashed vehicle identifier corresponding to each timestamp.

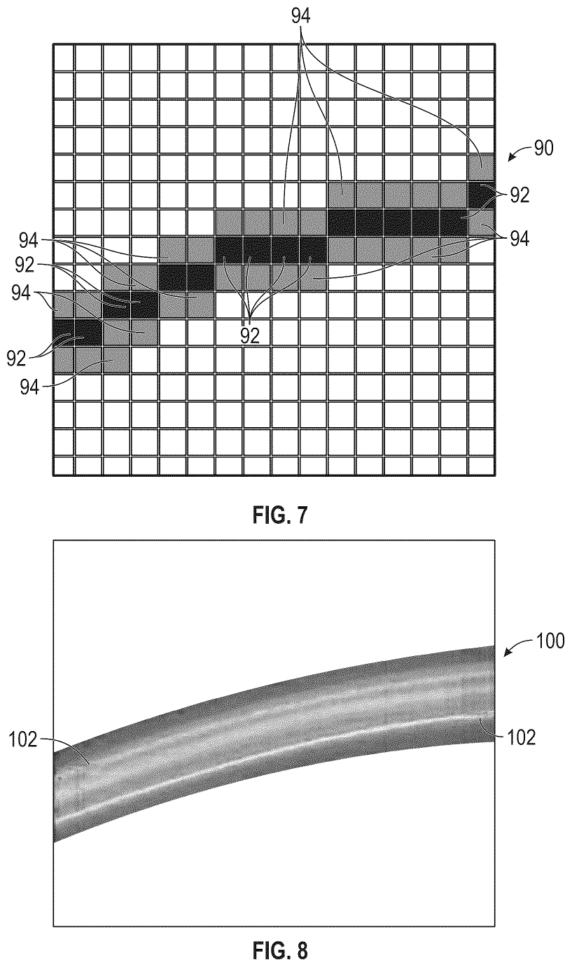

As explained below, the one or more central computers 20 rasterize the telemetry data received from the plurality of vehicles 12 into map content including a two-dimensional probability distribution 90 (shown in FIG. 7) that indicates a probability density of vehicles over a predefined period of time. In one non-limiting embodiment, the predefined period of time ranges from two to three weeks, however, it is to be appreciated that other periods of time may be used as well. In one embodiment, the map content is created specifically for an autonomous driving system such as, for example, an automated driving system (ADS) or an advanced driver assistance system (ADAS). After determining the map content, the one or more central computers 20 may share the map content with the plurality of vehicles 12.

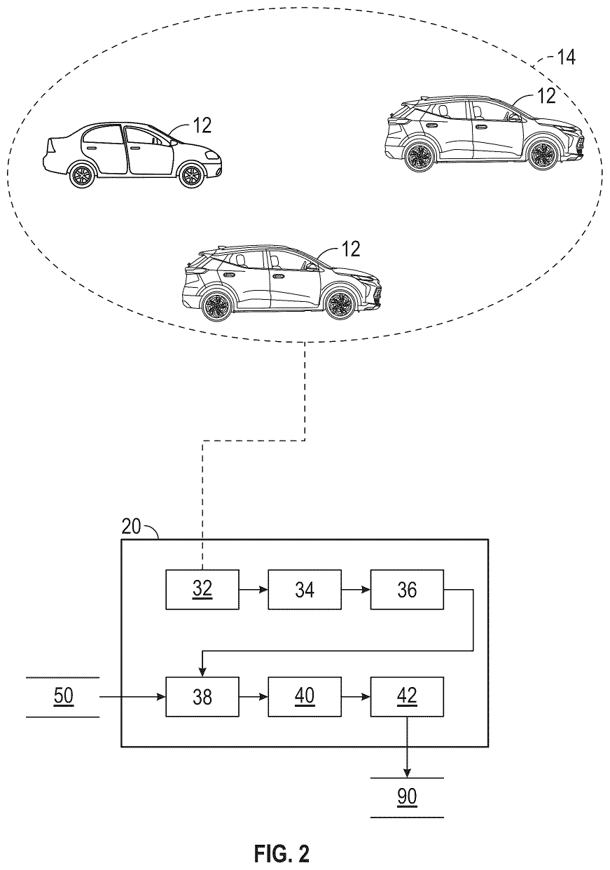

FIG. 2 is a block diagram illustrating the software architecture of the one or more central computers 20 shown in FIG. 1. In the example as shown in FIG. 2, the one or more central computers 20 includes a telemetry data module 32, a filtering module 34, a coordinate transformation module 36, a road segmentation module 38, a rasterization module 40, and an aggregation module 42. Referring to both FIGS. 1 and 2, the telemetry data module 32 of the one or more central computers 20 receives the telemetry data from the plurality of vehicles 12 situated within the predefined geofenced area 14, where the telemetry data is collected over the predefined period of time.

The filtering module 34 receives the telemetry data from the telemetry data module 32 and filters the telemetry data based on one or more telemetry data parameters. In one embodiment, the one or more telemetry data parameters include GPS boundary error, vehicle trajectories including temporal gaps that exceed a predefined period of time, a number of trajectories, and sample speed, however, it is to be appreciated that other types of parameters may be used as well. In one embodiment, the filtering module 34 filters the telemetry data to remove data points having a GPS boundary error that exceeds a predefined error threshold. In one embodiment, the predefined error threshold is about four meters, however, it is to be appreciated that other values may be used as well. The filtering module 34 may filter the telemetry data to split vehicle trajectories that include temporal gaps having a duration that exceeds the predefined period of time into two or more vehicle trajectories instead. The filtering module 34 may filter the telemetry data to remove vehicles from consideration that travel outside a sample speed range. For example, the sample speed range may represent medium driving speeds for a specific roadway, vehicles that are traveling relatively slowly or that are coming to a stop to perform a parking maneuver as well as vehicles driving at relatively high speeds, which all contribute to the issue of temporally spare data, would be removed from consideration. The coordinate transformation module 36 of the one or more central computers 20 receives the telemetry data from the filtering module 34 and performs a coordinate transform to convert the telemetry data, which is currently expressed in latitude and longitude, into Euclidian space.

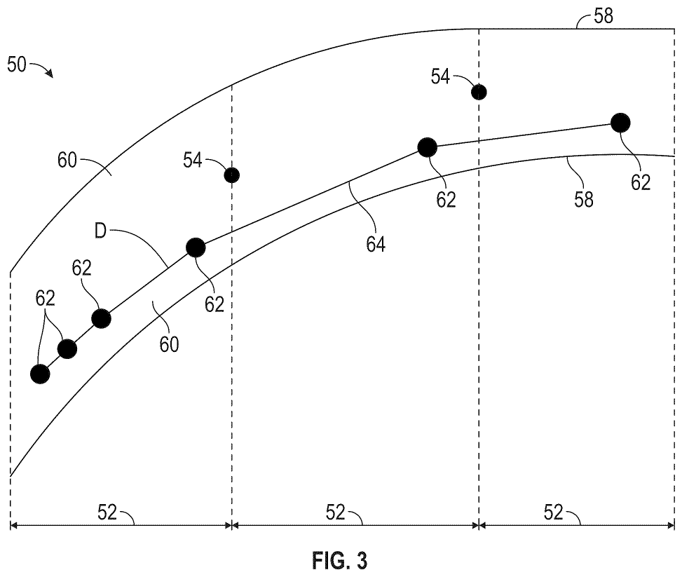

The road segmentation module 38 of the one or more central computers 20 receives road network data representing a road network 50 (shown in FIG. 3) that represents the predefined geofenced area 14 (FIG. 1) and the telemetry data from the plurality of vehicles 12 (FIG. 1). One example of road network data is the open street map (OSM), however, it is to be appreciated that other types of road network data may be used as well. Referring to FIGS. 2 and 3, the road network 50 is a network graph that models roadways based on a plurality of road segments 52, a plurality of endpoints 54, and opposing road edges 58, where each endpoint 54 represents an endpoint of one of the road segments 52. It is to be appreciated that the opposing road edges 58 represent theoretical lane or road edges, and not the opposing topological graph edges. In the embodiment as shown in FIG. 3, the road segments 52 includes two opposing lanes 60, where one of the lanes 60 directs traffic towards the east, and the remaining lane 60 directs traffic towards the west, however, it is to be appreciated that FIG. 3 is merely exemplary in nature and the road segments 52 may include any number of lanes with separate lane edges.

The road segmentation module 38 of the one or more central computers 20 executes one or more map matching algorithms to perform topology matching that aligns a plurality of telemetry data points 62 with the topology of the road network 50 based on a direction and a location of each telemetry data point 62, where the telemetry data points 62 each represent a trajectory of one of the plurality of vehicles 12 located in the predefined geofenced area 14 (FIG. 1) at a specific timestamp. Once the plurality of telemetry data points 62 are aligned based on topology matching, the road segmentation module 38 of the one or more central computers 20 may then filter the telemetry data to remove any trajectories that do not include at least a threshold number of telemetry data points 62. The threshold number of telemetry data points 62 is selected to omit incomplete vehicle trajectories. In one non-limiting embodiment, the threshold number of telemetry data points 62 is three. The road segmentation module 38 of the one or more central computers 20 may then order the plurality of telemetry data points 62 sequentially based on the individual timestamp corresponding to each telemetry data point 62. The road segmentation module 38 of the one or more central computers 20 then overlays the telemetry data points 62 upon the road network 50, which is shown in FIG. 3.

It is to be appreciated that the telemetry data points 62 are temporally sparse. Furthermore, it is also to be appreciated that although the telemetry data points 62 are temporally equidistant, the telemetry data points 62 are not spatially uniform. Indeed, as seen in FIG. 3, the telemetry data points 62 are not spaced at equal distances from one another.

The road segmentation module 38 of the one or more central computers 20 then calculates a spline 64 that connects the telemetry data points 62 to one another, where the spline 64 represents the trajectory of a single vehicle 12. It is to be appreciated that the road segmentation module 38 executes any type of parametric spline algorithm to calculate the spline 64. In one non-limiting embodiment, the parametric spline algorithm is a parametric cubic B-spline algorithm, however, it is to be appreciated that other types of parametric spline algorithms may be used as well.

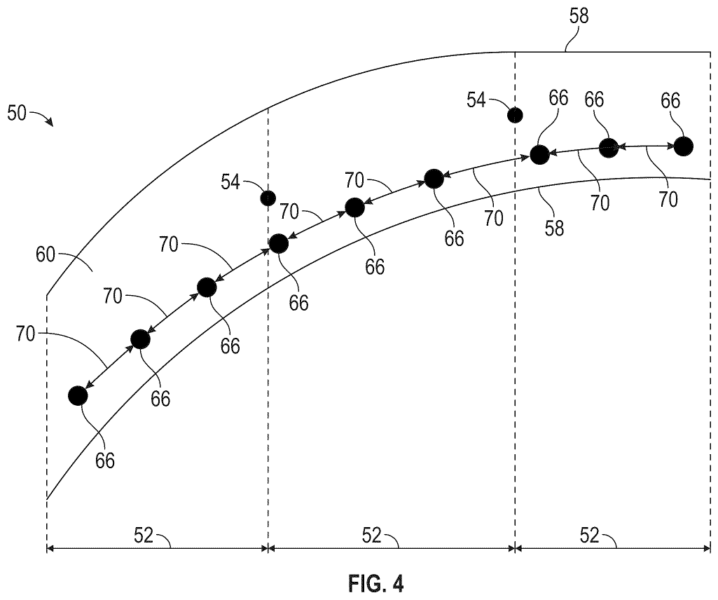

Once the spline 64 that connects the telemetry data points 62 is calculated, the road segmentation module 38 of the one or more central computers 20 determines a plurality of interpolated telemetry data points 66 (FIG. 4) positioned at equidistant intervals 70 from one another along the spline 64. That is, the road segmentation module 38 transforms the telemetry data points 62, which are temporally equidistant but are positioned spatially unequal to one another, into the interpolated telemetry data points 66. The distance measured between the equidistant intervals 70 is based on the specific application of the map content. For example, if the map content is created for an autonomous driving system such as ADS or ADAS, then the distance between the equidistant intervals 70 is about one meter.

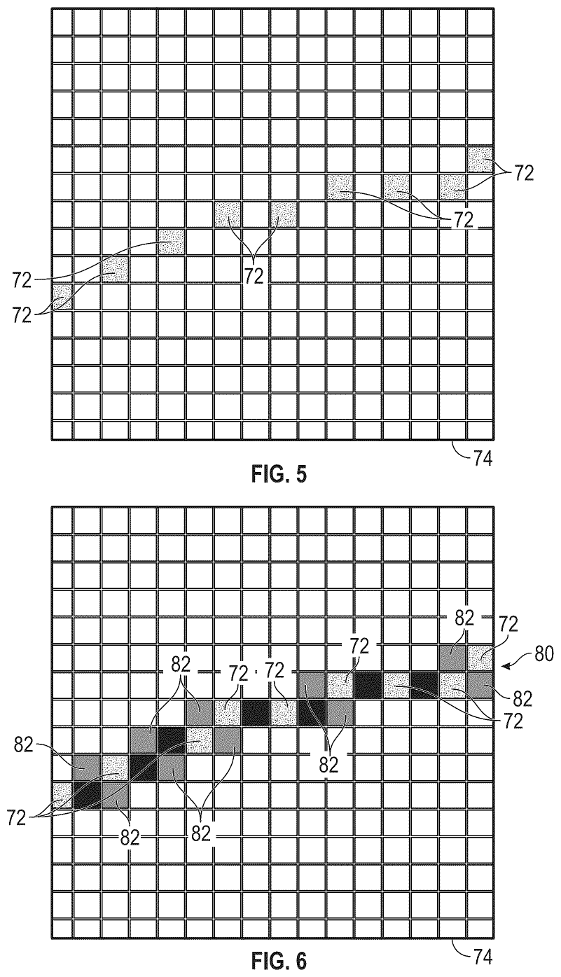

Referring to FIGS. 1, 2, 4, and 5, the rasterization module 40 of the one or more central computers 20 rasterizes the interpolated telemetry data points 66, which are expressed in Euclidean space, into discrete pixels 72 (shown in FIG. 5) that are expressed in image space. Specifically, the rasterization module 40 of the one or more central computers 20 rasterizes the interpolated telemetry data points 66 into discrete pixels 72 by first identifying the interpolated telemetry data points 66 within the predefined geofenced area 14 within the Euclidean space, where the the predefined geofenced area 14 is represented by plurality of image tiles 74. It is to be appreciated that a single image tile 74 is shown in FIG. 5. The image tiles 74 extend along the road segments 52 (FIG. 3) of the road network 50 to capture the trajectory of the vehicle 12. The rasterization module 40 of the one or more central computers 20 discretizes the interpolated telemetry data points 66 (FIG. 4) located within the the predefined geofenced area 14, which are expressed in the Euclidean space, into the discrete pixels 72, which are expressed in image space. In the non-limiting embodiment as shown in FIG. 5, the image space is a 512 x 512 pixel grid, however, it is to be appreciated that FIG. 5 is merely exemplary in nature and other types of image spaces may be employed instead. The rasterization module 40 of the one or more central computers 20 executes one or more line drawing programs to draw a line 80 (shown in FIG. 6) that includes the discrete pixels 72. In the embodiment as shown in FIG. 6, the line 80 is an anti-aliased line including partially transparent pixels 82, however, it is to be appreciated that an aliased line may be used as well. However, it is to be appreciated that an anti-aliased line may provide a smoother profile over rasterized space.

The aggregation module 42 of the one or more central computer 20 receives the lines 80 corresponding to each vehicle 12 located within the predefined geofenced area 14 (FIG. 1). The aggregation module 42 determines a two-dimensional probability distribution 90 (shown in FIG. 7) that indicates a probability density of the vehicles 12 over the predefined period of time along particular road segment 52 (FIG. 3) located within the predefined geofenced area 14 based on the lines 80 for each vehicle 12 located within the predefined geofenced area 14. Specifically, the aggregation module 42 aggregates the lines 80 for each vehicle 12 located within the predefined geofenced area 14 to determine an aggregated line 92, which is shown in FIG. 7 as part of the two-dimensional probability distribution 90. The aggregated line 92 is a solid line and represents an aggregation of the lines 80 for each vehicle 12 located within the predefined geofenced area 14. The probability boundary 94 surrounds the aggregated line 92 and is representative of the GPS boundary error of each of the vehicle 12 located within the predefined geofenced area 14. As seen in FIG. 7, the two-dimensional probability distribution 90 includes the aggregated line 92 and the probability boundary 94.

The aggregation module 42 of the one or more central computers 20 may then transform the two-dimensional probability distribution 90, which is expressed in image space, into a rendered probability density image 100, which is shown in FIG. 8. In the embodiment as shown in FIG. 8, the rendered probability density image 100 is expressed in grayscale. However, in another implementation, the rendered probability density image 100 may be expressed as a red, green, blue (RGB) image that includes values ranging from 0 to 255. In the event the rendered probability density image 100 is expressed in grayscale, then the brighter areas 102 within the rendered probability density image 100 represent higher density areas including more vehicles 12. Furthermore, the rendered probability density image 100 includes statistics such as, for example, speed, heading, and trip count.

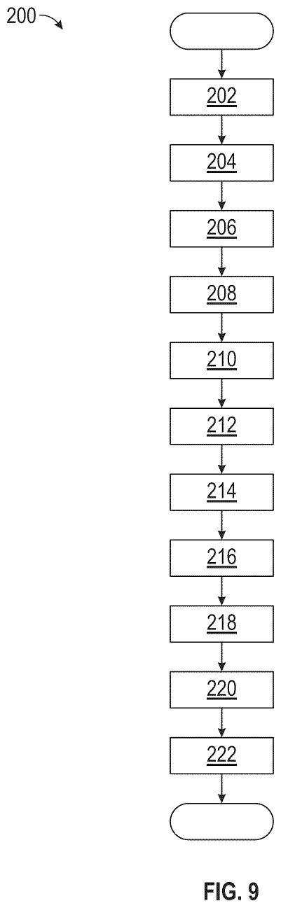

FIG. 9 is a process flow diagram illustrating a method 200 for rasterizing telemetry data collected from the plurality of vehicles 12 (FIG. 1) into map content. Referring generally to FIGS. 1-9, the method 200 may begin at block 202. In block 202, the telemetry data module 32 of the one or more central computers 20 receives the telemetry data from the plurality of vehicles 12 situated within the predefined geofenced area 14. The method 200 may then proceed to block 204.

In block 204, the filtering module 34 of the one or more central computers 20 filters the telemetry data based on one or more telemetry data parameters. The method 200 may then proceed to block 206.

In block 206, the coordinate transformation module 36 of the one or more central computers 20 performs a coordinate transform to convert the telemetry data, which is currently expressed in latitude and longitude, into Euclidian space. The method 200 may then proceed to block 208.

In block 208, the road segmentation module 38 of the one or more central computers 20 receives road network data representing a road network 50 (shown in FIG. 3) that represents the predefined geofenced area 14 (FIG. 1) and the telemetry data from the plurality of vehicles 12 (FIG. 1). The method 200 may then proceed to block 210.

In block 210, the road segmentation module 38 of the one or more central computers 20 executes one or more map matching algorithms to perform topology matching that aligns the plurality of telemetry data points 62 (shown in FIG. 3) with the topology of the road network 50 based on a direction and a location of each telemetry data point 62, where the telemetry data points 62 each represent a trajectory of one of the plurality of vehicles 12 located in the predefined geofenced area 14 (FIG. 1) at a specific timestamp. The method 200 may then proceed to block 212.

In block 212, the road segmentation module 38 of the one or more central computers 20 calculates the spline 64 (shown in FIG. 3) that connects the telemetry data points 62 to one another, where the spline 64 represents the trajectory of a single vehicle 12. The method 200 may then proceed to block 214.

In block 214, the road segmentation module 38 of the one or more central computers 20 determines the plurality of interpolated telemetry data points 66 (FIG. 4) positioned at equidistant intervals 70 from one another along the spline 64. The method 200 may then proceed to block 216.

In block 216, the rasterization module 40 of the one or more central computers 20 rasterizes the interpolated telemetry data points 66, which are expressed in Euclidean space, into a plurality of discrete pixels 72 (shown in FIG. 5) that are expressed in image space. The plurality of discrete pixels 72, which are expressed in image space, are representative of the interpolated telemetry data points 66, which are expressed in Euclidean space. The method 200 may then proceed to block 218.

In block 218, the rasterization module 40 of the one or more central computers 20 executes one or more line drawing programs to draw a line 80 (shown in FIG. 6) that includes the plurality of discrete pixels 72. In the embodiment as shown in FIG. 6, the line 80 is an anti-aliased line including partially transparent pixels 82, however, it is to be appreciated that an aliased line may be used as well. The method 200 may then proceed to block 220.

In block 220, the aggregation module 42 of the one or more central computers 20 determines a two-dimensional probability distribution 90 (shown in FIG. 7) that indicates a probability density of the vehicles 12 over the predefined period of time along a particular road segment 52 (FIG. 3) located within the predefined geofenced area 14 based on a plurality of lines 80 that each correspond to one of the plurality of vehicles 12 located within the predefined geofenced area 14. The method 200 may then proceed to block 222.

In block 222, the aggregation module 42 of the one or more central computers 20 transforms the two-dimensional probability distribution 90, which is expressed in image space, into the rendered probability density image 100, which is shown in FIG. 8. The method 200 may then terminate.

Referring generally to the figures, the disclosed system for rasterizing telemetry data collected from the plurality of vehicles into map content provides various technical effects and benefits. Specifically, the disclosed system provides an efficient approach for aggregating and rasterizing high-volume, temporally sparse telemetry data into map content including probability images, while maintaining temporal precision. It is to be appreciated that the probability images, which indicate where vehicles are driving with a specific frequency, are determined based on thousands, and in some instances millions, of telemetry data records per road segment.

The central computers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for rasterizing telemetry data collected from a plurality of vehicles into map content, the system comprising:
one or more central computers in wireless communication with the plurality of vehicles that are each situated within a predefined geofenced area, wherein the one or more central computers receive the telemetry data from each of the plurality of vehicles, the one or more central computers executing instructions to:
receive road network data representing a road network for the predefined geofenced area, wherein the road network is a network graph that models roadways based on a plurality of road segments;
execute one or more map matching algorithms to perform topology matching that aligns a plurality of telemetry data points with a topology of the road network, wherein the plurality of telemetry data points each represent a trajectory of one of the plurality of vehicles;
calculate a spline that connects the plurality of telemetry data points to one another, wherein the spline represents a trajectory of a single vehicle;
determine a plurality of interpolated telemetry data points positioned at equidistant intervals from one another along the spline;
execute one or more line drawing programs that draw a line including a plurality of discrete pixels, wherein the plurality of discrete pixels, which are expressed in image space, are representative of the interpolated telemetry data points, which are expressed in Euclidean space; and
determine a two-dimensional probability distribution indicating a probability density of the plurality of vehicles over a predefined period of time along a particular road segment located within the predefined geofenced area based on a plurality of lines that each correspond to one of the plurality of vehicles.

2. The system of claim 1, wherein the one or more central computers execute instructions to:
transform the two-dimensional probability distribution into a rendered probability density image.

3. The system of claim 2, wherein the rendered probability density image is expressed as one of the following: grayscale and a red, green, blue (RGB) image.

4. The system of claim 1, wherein the two-dimensional probability distribution includes an aggregated line and a probability boundary.

5. The system of claim 4, wherein the aggregated line is a solid line and represents an aggregation of the plurality of lines that each correspond to one of the plurality of vehicles.

6. The system of claim 4, wherein the probability boundary surrounds the aggregated line and is representative of a global positioning system (GPS) boundary error of each of the plurality of vehicles located within the predefined geofenced area.

7. The system of claim 1, wherein the one or more central computers execute instructions to:
filter the telemetry data based on one or more telemetry data parameters.

8. The system of claim 7, wherein the one or more telemetry data parameters include one or more of the following: GPS boundary error, vehicle trajectories including temporal gaps that exceed a predefined period of time, a number of trajectories, and sample speed.

9. The system of claim 1, wherein the one or more central computers execute instructions to:
execute a parametric spline algorithm to calculate the spline.

10. The system of claim 9, wherein the parametric spline algorithm is a parametric cubic B-spline algorithm.

11. The system of claim 1, wherein a distance measured between the equidistant intervals is determined based on the specific application of the map content.

12. The system of claim 1, wherein the line is an anti-aliased line.

13. The system of claim 1, wherein the telemetry data indicates one or more of the following: a position of a specific vehicle, GPS boundary error, vehicle speed, heading, elevation, and a hashed vehicle identifier corresponding to each timestamp.

14. A method for rasterizing telemetry data collected from a plurality of vehicles into map content, the method comprising:
receiving, by one or more central computers, road network data representing a road network for a predefined geofenced area, wherein the road network is a network graph that models roadways based on a plurality of road segments;
executing, by the one or more central computers, one or more map matching algorithms to perform topology matching that aligns a plurality of telemetry data points with a topology of the road network, wherein the plurality of telemetry data points each represent a trajectory of one of the plurality of vehicles;
calculating, by the one or more central computers, a spline that connects the plurality of telemetry data points to one another, wherein the spline represents a trajectory of a single vehicle;
determining, by the one or more central computers, a plurality of interpolated telemetry data points positioned at equidistant intervals from one another along the spline;
executing one or more line drawing programs that draw a line including a plurality of discrete pixels, wherein the plurality of discrete pixels, which are expressed in image space, are representative of the interpolated telemetry data points, which are expressed in Euclidean space; and
determining a two-dimensional probability distribution indicating a probability density of the plurality of vehicles over a predefined period of time along a particular road segment located within the predefined geofenced area based on a plurality of lines that each correspond to one of the plurality of vehicles.

15. The method of claim 14, further comprising:
transforming the two-dimensional probability distribution into a rendered probability density image.

16. A system for rasterizing telemetry data collected from a plurality of vehicles into map content, the system comprising:
one or more central computers in wireless communication with the plurality of vehicles that are each situated within a predefined geofenced area, wherein the one or more central computers receive the telemetry data from each of the plurality of vehicles, the one or more central computers executing instructions to:
receive road network data representing a road network for the predefined geofenced area, wherein the road network is a network graph that models roadways based on a plurality of road segments;
execute one or more map matching algorithms to perform topology matching that aligns a plurality of telemetry data points with a topology of the road network, wherein the plurality of telemetry data points each represent a trajectory of one of the plurality of vehicles;
calculate a spline that connects the plurality of telemetry data points to one another, wherein the spline represents a trajectory of a single vehicle;
determine a plurality of interpolated telemetry data points positioned at equidistant intervals from one another along the spline;
execute one or more line drawing programs that draw an anti-aliased line including a plurality of discrete pixels, wherein the plurality of discrete pixels, which are expressed in image space, are representative of the interpolated telemetry data points, which are expressed in Euclidean space;
determine a two-dimensional probability distribution indicating a probability density of the plurality of vehicles over a predefined period of time along a particular road segment located within the predefined geofenced area based on a plurality of anti-aliased lines that each correspond to one of the plurality of vehicles; and
transform the two-dimensional probability distribution into a rendered probability density image.

17. The system of claim 16, wherein the rendered probability density image is expressed as one of the following: grayscale and a red, green, blue (RGB) image.

18. The system of claim 16, wherein the two-dimensional probability distribution includes an aggregated line and a probability boundary.

19. The system of claim 18, wherein the aggregated line is a solid line and represents an aggregation of the plurality of lines that each correspond to one of the plurality of vehicles.

20. The system of claim 19, wherein the probability boundary surrounds the aggregated line and is representative of a GPS boundary error of each of the plurality of vehicles located within the predefined geofenced area.
